(19) United States
(12) Patent Application Publication
(10) Pub. No.: US 2017/0151843 A1
(43) Pub. Date: Jun. 1, 2017

(54) TIRE OF WHICH THE CROWN AREA IS PROVIDED WITH A SUB-LAYER COMPRISING A THERMOPLASTIC ELASTOMER AND A CONDUCTIVE FILLER

(71) Applicants: COMPAGNIE GENERALE DES ETABLISSEMENTS MICHELIN, CLERMONT-FERRAND (FR); Michelin Recherche et Technique S.A., GRANGES-PACCOT (CH)

(72) Inventors: EMMANUEL CUSTODERO, CLERMONT-FERRAND (FR); VINCENT ABAD, CLERMONT-FERRAND (FR); ROMAIN LIBERT, CLERMONT-FERRAND (FR)

(21) Appl. No.: 15/312,962

(22) PCT Filed: May 26, 2015
(86) PCT No.: PCT/EP2015/061559

§ 371 Date: Nov. 21, 2016

(30) Foreign Application Priority Data
May 27, 2014 (FR) 1454785

(51) Int. Cl. B60C 99/00; B60C 1/00; C08L 9/06; B60C 11/00

(52) U.S. Cl. CPC B60C 99/003; B60C 11/005; B60C 1/0016; C08L 9/06

(57) ABSTRACT

A radial tire (1) for a motor vehicle comprises a crown (2) comprising a tread (3) provided with at least a radially outer part (3a) intended to come into contact with the road; two non-stretchable beads (4), two sidewalls (5) connecting the beads (4) to the tread (3), a carcass reinforcement (6) passing into the two sidewalls (5) and anchored in the beads (4); a crown reinforcement or belt (7) positioned circumferentially between the radially outer part (3a) of the tread (3) and the carcass reinforcement (6); a radially inner elastomer layer (8) referred to as “underlayer”, which is positioned circumferentially between the radially outer part (3a) of the tread (3) and the carcass reinforcement (6), which comprises at least one thermoplastic elastomer which is a block copolymer comprising at least one elastomer block and at least one thermoplastic block, and which also comprises at least one conductive filler.

The present invention relates to tyres comprising a composition based on thermoplastic elastomers (TPEs) in their crown.

As the tread of tyres is the part of the tyre in contact with the running surface, it is the part of the tyre which wears furthest and fastest. An advantageous objective for tyre manufacturers is to be capable of removing the tread from a tyre, which operation is commonly known as tread separation, in order to replace it with another tread, which operation is commonly known as retreading, in order to prolong the lifetime of a tyre without having to completely change it. However, with the materials used to date, the tread separation operation remains complex and thus expensive. This is one of the reasons why the tyres of passenger vehicles are today very seldom retreaded. It would thus be highly advantageous to find a means for more effectively separating tread from and retreading tyres.

With this aim, the Applicant Company has found that a specific tread underlayer makes it possible to facilitate the operations of separating tread from and retreading the tyre provided with such an underlayer. Such an underlayer is described in the document WO 2013/149803.

The Applicant Company has now found a means for further improving this underlayer so as to further facilitate the operations of separating tread from and retreading the tyre provided with such an underlayer.

A subject-matter of the invention is a radial tyre for a motor vehicle, comprising:
a crown comprising a tread provided with at least a radially outer part intended to come into contact with the road;
two non-stretchable beads, two sidewalls connecting the beads to the tread, a carcass reinforcement passing into the two sidewalls and anchored in the beads;
a crown reinforcement or belt positioned circumferentially between the radially outer part of the tread and the carcass reinforcement;
a radially inner elastomer layer referred to as “underlayer” (or tread underlayer), having a formulation different from the formulation of the radially outer part of the tread, this underlayer being itself positioned circumferentially between the radially outer part of the tread and the carcass reinforcement;
   characterized in that the said underlayer comprises at least one thermoplastic elastomer, the said thermoplastic elastomer being a block copolymer comprising at least one elastomer block and at least one thermoplastic block, the total content of thermoplastic elastomer being within a range varying from 65 to 100 phr (parts by weight per hundred parts of elastomer), the said underlayer also comprising at least one conductive filler, the said conductive filler being a graphitized or partially graphitized carbon black.

The presence of a conductive filler renders the underlayer sensitive to electric conduction heating. Thus, by the simple application of an electric current, it is possible to raise, with a degree of selectivity, the temperature of the underlayer due to the Joule effect, until it reaches melting point, without for all that heating the adjacent layers, which makes it possible to limit the thermal damage which they might experience during a general heating of the tyre.

A major advantage of the invention is to make possible a saving in materials since, instead of changing the entire tyre, it becomes possible very easily to change only the worn tread. This saving is furthermore highly favourable to the protection of the environment.

Preferably, the invention relates to a tyre as defined above, in which the number-average molecular weight of the thermoplastic elastomer is between 30 000 and 500 000 g/mol.

More preferably, the invention relates to a tyre as defined above, in which the elastomer block or blocks of the block copolymer are chosen from elastomers having a glass transition temperature of less than 25° C., preferably selected from the group consisting of ethylene elastomers, diene elastomers and their mixtures, more preferably from diene elastomers.

More preferably still, the invention relates to a tyre as defined above, in which the elastomer block or blocks of the block copolymer are diene elastomers resulting from isoprene, butadiene or a mixture of the latter.

Preferably, the invention relates to a tyre as defined above, in which the thermoplastic block or blocks of the block copolymer are chosen from polymers having a glass transition temperature of greater than 80° C. and, in the case of a semicrystalline thermoplastic block, a melting point of greater than 80° C., and, in particular, the thermoplastic block or blocks of the block copolymer are selected from the group consisting of polyolefins, polyurethanes, polyamides, polyesters, polyacetals, polyethers, polyphenylene sulphides, polyfluorinated compounds, polystyrenes, polycarbonates, polysulphones, polymethyl methacrylate, polyetherimide, thermoplastic copolymers and their mixtures, and, more preferably, the thermoplastic block or blocks of the block copolymer are chosen from polystyrenes.

Preferably again, the invention relates to a tyre as defined above, in which the thermoplastic elastomer or elastomers are selected from the group consisting of styrene/butadiene (SB), styrene/isoprene (SI), styrene/butadiene/isoprene (SBI), styrene/butadiene/styrene (SBS), styrene/isoprene/styrene (SIS) and styrene/butadiene/isoprene/styrene (SBIS) thermoplastic elastomers and the mixtures of these copolymers.

Preferably, the invention relates to a tyre as defined above in which the conductive filler is an electric conductive carbon black specific surface of greater than 65 m²/g, preferably of greater than 100 m²/g and more preferably of greater than 500 m²/g.

Preferably again, the invention relates to a tyre as defined above, in which the conductive filler is present at a content corresponding to from 10% to 25% by volume of the composition, preferably from 10% to 18% by volume of the composition and more preferably from 12% to 18% by volume of the composition.

According to a preferred form, the invention relates to a tyre as defined above, in which the thermoplastic elastomer is the only elastomer of the underlayer.

According to another preferred form, the invention relates to a tyre as defined above, in which the underlayer additionally comprises a non-thermoplastic elastomer at a content of at most 35 phr.

Preferably, the invention relates to a tyre as defined above, in which the underlayer additionally comprises at least one polyether-based thermoplastic polymer. Preferably, the polyether-based thermoplastic polymer is chosen from poly(para-phenylene ether) polymers. More preferably, the content of polyether-based thermoplastic polymer is less than 40 phr, preferably between 2 and 35 phr.

Preferably, the invention relates to a tyre as defined above, in which the underlayer is devoid of thermoplastic polymer other than a polyether or comprises less than 30 phr, preferably less than 10 phr, thereof.

Very preferably, the invention relates to a tyre as defined above, in which the underlayer does not comprise a crosslinking system.

The invention also preferably relates to a tyre as defined above, in which the following equation is adhered to for the underlayer with each of the layers adjacent to the underlayer:

$$\frac{\frac{{G}_{A}^{′} ( 200 ° C . )}{{G}_{A}^{′} ( 60 ° C . )}}{\frac{{G}_{B}^{′} ( 200 ° C . )}{{G}_{B}^{′} ( 60 ° C . )}} \leq 0.6$$

and more preferably the following equation is adhered to for the underlayer with each of the layers adjacent to the underlayer:

$$\frac{\frac{{G}_{A}^{′} ( 200 ° C . )}{{G}_{A}^{′} ( 60 ° C . )}}{\frac{{G}_{B}^{′} ( 200 ° C . )}{{G}_{B}^{′} ( 60 ° C . )}} \leq 0.5$$

Preferably, the invention relates to a tyre as defined above, in which the following equation is adhered to for the underlayer:

$$\frac{{G}_{A}^{′} ( 100 ° C . )}{{G}_{A}^{′} ( 60 ° C . )} > 0.4$$

and more preferably the following equation is adhered to for the underlayer:

$$\frac{{G}_{A}^{′} ( 100 ° C . )}{{G}_{A}^{′} ( 60 ° C . )} > 0.5$$

The invention relates more particularly to the tyres intended to equip motorless vehicles, such as bicycles, or motor vehicles of the following types: passenger vehicles, SUVs (Sport Utility Vehicles), two-wheel vehicles (in particular motorcycles), aircraft, as well as industrial vehicles chosen from vans, heavy-duty vehicles—that is to say, underground trains, buses, heavy road transport vehicles (lorries, tractors, trailers) or off-road vehicles, such as agricultural vehicles or earthmoving equipment—, or other transportation or handling vehicles.

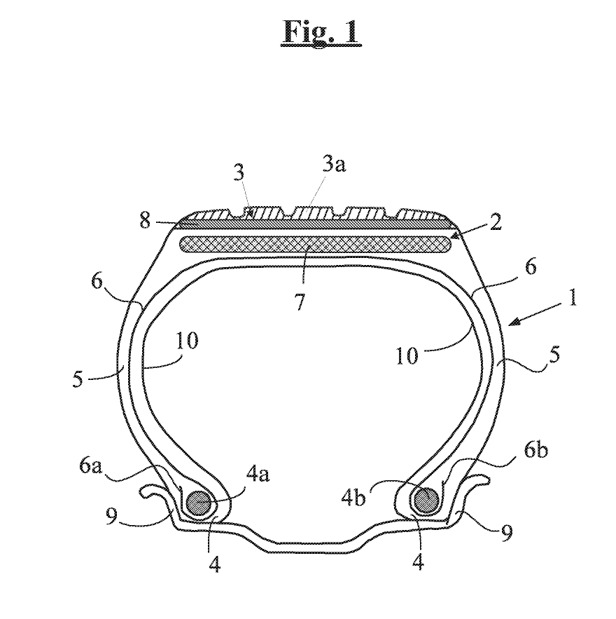

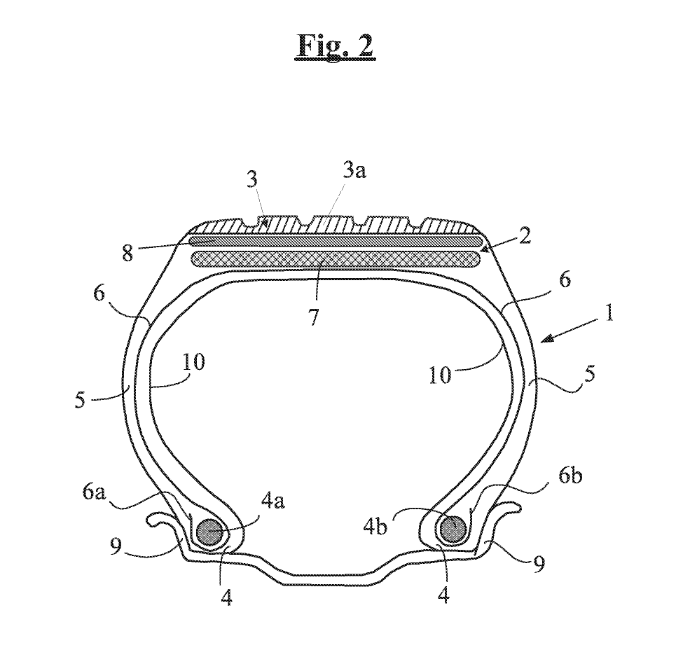

The invention and its advantages will be easily understood in the light of the description and implementational examples which follow, and also of FIGS. 1 and 2 relating to these examples, which diagrammatically represent, in radial cross section, examples of radial tyres in accordance with the invention.

### DETAILED DESCRIPTION OF THE INVENTION

In the present description, unless expressly indicated otherwise, all the percentages (%) shown are percentages by weight.

Within the meaning of the present invention, the underlayer is positioned circumferentially inside the crown of the tyre, between, on the one hand, the radially outermost part of its tread, that is to say the portion intended to come into contact with the road during running, and, on the other hand, the crown reinforcement. Underlayer is thus understood to mean any part made of rubber which is radially external to the crown reinforcement of the tyre which does not open onto the outside of the tyre, which has no contact with the air or an inflating gas, in other words which is thus situated in the actual interior of the tread or between the latter and the belt (or crown reinforcement) of the tyre.

It thus has to be understood that this underlayer can be positioned:
either in the tread itself, but in this case radially under the tread patterned portion (that is to say, radially internally with respect to this portion) which is intended to come into contact with the road during the running of the tyre, throughout the lifetime of the latter;
or under the tread (that is to say, radially internally with respect to this tread), between the tread and the belt (or crown reinforcement).

Preferably, this underlayer is the only layer located between the tread and the crown reinforcement, or else located inside the tread.

The appended FIGS. 1 and 2 represent, in radial cross section, very diagrammatically (in particular without observing a specific scale), two preferred examples of tyres for a motor vehicle having a radial carcass reinforcement which are in accordance with the invention.

FIG. 1 illustrates a first possible embodiment of the invention, according to which the underlayer (8) is incorporated in the tread (3) itself but positioned under the portion (3a) of the tread which is intended to come into contact with the road during running, in order to form what it is customary to call an underlayer of the tread. It may also be remembered that, in such a case, the tread is also commonly referred to, by a person skilled in the art, as tread having a “cap-base” structure, the term “cap” denoting the patterned portion of the tread intended to come into contact with the road and the term “base” denoting the non-patterned portion of the tread, having a different formulation, which, for its part, is not intended to come into contact with the road.

In this FIG. 1, the diagrammatically represented tyre (1) comprises a crown (2) comprising a tread (3) (in order to simplify, comprising a very simple pattern), the radially outer part (3a) of which is intended to come into contact with the road, two non-stretchable beads (4) in which a carcass reinforcement (6) is anchored. The crown (2), joined to the said beads (4) by two sidewalls (5), is, in a way known per se, reinforced by a crown reinforcement or “belt” (7) which is at least partly metallic and which is radially outer with respect to the carcass reinforcement (6).

More specifically, a tyre belt is generally composed of at least two superimposed belt plies, sometimes referred to as “working” plies or “crossed” plies, the reinforcing elements or “reinforcers” of which are positioned virtually parallel to one another inside a ply, but crossed from one ply to the other, that is to say inclined, symmetrically or asymmetrically, with respect to the median circumferential plane, by an angle which is generally between 10° and 45°, according to the type of tyre under consideration. Each of these two crossed plies is composed of a rubber matrix or “calendering rubber” which coats the reinforcers. In the belt, the crossed plies can be supplemented by various other auxiliary rubber plies or layers, with widths which can vary as the case may be, comprising or not comprising reinforcers; mention will be made, by way of example, of simple rubber cushions, “protection” plies having the role of protecting the remainder of the belt from external attacks or perforations, or also “hooping” plies comprising reinforcers oriented substantially along the circumferential direction (“zero-degree” plies), whether radially outer or inner with respect to the crossed plies.

For the reinforcing of the above belts, in particular of their crossed plies, protection plies or hooping plies, use is generally made of reinforcers in the form of steel cords or textile cords composed of thin wires or yarns assembled together by braiding or twisting.

The carcass reinforcement (6) is here anchored in each bead (4) by winding around two bead threads (4a, 4b), the turn-up (6a, 6b) of this reinforcement (6) being, for example, positioned towards the outside of the tyre (1), which is here represented fitted to its wheel rim (9). The carcass reinforcement (6) is composed of at least one ply reinforced by radial textile cords, that is to say that these cords are positioned virtually parallel to one another and extend from one bead to the other so as to form an angle of between 80° and 90° with the median circumferential plane (plane perpendicular to the axis of rotation of the tyre which is located halfway between the two beads 4 and passes through the middle of the crown reinforcement 7). Of course, this tyre (1) additionally comprises, in a known way, a layer (10) of inner gum or elastomer (commonly known as “inner liner”) which defines the radially inner face of the tyre and which is intended to protect the carcass ply from the diffusion of air originating from the space interior to the tyre.

This example of a tyre (1) in accordance with the invention of FIG. 1 is characterized in that the base part (8) of its tread (3) is composed of the underlayer which is described in detail subsequently.

FIG. 2 illustrates another possible embodiment of the invention, according to which the underlayer (8) is external to the tread (i.e., separate from the latter), this time positioned, still in the crown (2), below the tread (i.e., radially internally with respect to the latter) and above the belt (i.e., radially externally with respect to the latter), in other words between the tread (3) and the belt (7).

This underlayer preferably has a thickness between 0.02 and 5 mm, preferably between 0.05 and 3 mm. According to a preferred form, this thickness is preferably between 0.2 and 3 mm, more preferably between 0.5 and 2.5 mm and more preferably still between 1 and 2.5 mm. According to another preferred embodiment, this thickness is between 0.05 and 0.25 mm, more preferably 0.05 and 0.15 mm. A person skilled in the art will easily understand that this thickness will be variable from one application to another, according to the destination of the tyres (two-wheel vehicles, passenger vehicles, heavy-duty vehicles, earthmoving equipment).

Furthermore, the term “phr” means, within the meaning of the present patent application, parts by weight per hundred parts of elastomer, thermoplastic and non-thermoplastic elastomers mixed together. Within the meaning of the present invention, thermoplastic elastomers (TPEs) are included among the elastomers.

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

### 1. Composition of the Underlayer

The tyre according to the invention has the essential characteristic of being provided with an elastomer layer, referred to as “underlayer”, having a formulation different from the patterned external portion of the tread, the said underlayer comprising at least one thermoplastic elastomer, the said thermoplastic elastomer being a block copolymer comprising at least one elastomer block and at least one thermoplastic block, and the total content of thermoplastic elastomer being within a range varying from 65 to 100 phr (parts by weight per hundred parts of elastomer), the said underlayer also comprising at least one conductive filler.

### 1.1. Thermoplastic Elastomer (TPE)

Thermoplastic elastomers (abbreviated to “TPEs”) have a structure intermediate between thermoplastic polymers and elastomers. These are block copolymers composed of rigid thermoplastic blocks connected via flexible elastomer blocks.

The thermoplastic elastomer used for the implementation of the invention is a block copolymer, the chemical nature of the thermoplastic and elastomer blocks of which can vary.

### 1.1.1. Structure of the TPE

The number-average molecular weight (denoted Mn) of the TPE is preferably between 30 000 and 500 000 g/mol, more preferably between 40 000 and 400 000 g/mol. Below the minima indicated, there is a risk of the cohesion between the elastomer chains of the TPE being affected, in particular due to its possible dilution (in the presence of an extending oil); furthermore, there is a risk of an increase in the working temperature affecting the mechanical properties, in particular the properties at break, with the consequence of a reduced “hot” performance. Furthermore, an excessively high Mn weight can be damaging to the implementation. Thus, it has been found that a value within a range from 50 000 to 300 000 g/mol is particularly well suited, in particular to use of the TPE in a tyre underlayer composition.

The number-average molecular weight (Mn) of the TPE elastomer is determined, in a known manner, by steric exclusion chromatography (SEC). For example, in the case of thermoplastic styrene elastomers, the sample is dissolved beforehand in tetrahydrofuran at a concentration of approximately 1 g/l and then the solution is filtered through a filter with a porosity of 0.45 μm before injection. The apparatus used is a Waters Alliance chromatographic line. The elution solvent is tetrahydrofuran, the flow rate is 0.7 ml/min, the temperature of the system is 35° C. and the analytical time is 90 min. A set of four Waters columns in series, with the Styragel tradenames (HIMW7, HMW6E and two HT6E), is used. The injected volume of the solution of the polymer sample is 100 μl. The detector is a Waters 2410 differential refractometer and its associated software, for making use of the chromatographic data, is the Waters Millennium system. The calculated average molar masses are relative to a calibration curve produced with polystyrene standards. The conditions can be adjusted by a person skilled in the art.

The value of the polydispersity index PI (reminder: PI=Mw/Mn, with Mw the weight-average molecular weight and Mn the number-average molecular weight) of the TPE is preferably less than 3, more preferably less than 2 and more preferably still less than 1.5.

In the present patent application, when reference is made to the glass transition temperature of the TPE, it concerns the Tg relative to the elastomer block. The TPE preferably exhibits a glass transition temperature (“Tg”) which is preferably less than or equal to 25° C., more preferably less than or equal to 10° C. A Tg value greater than these minima can reduce the performance of the underlayer when used at very low temperature; for such a use, the Tg of the TPE is more preferably still less than or equal to −10° C. Preferably again, the Tg of the TPE is greater than −100° C.

In a known way, TPEs exhibit two glass transition temperature peaks (Tg, measured according to ASTM D3418), the lowest temperature being relative to the elastomer part of the TPE and the highest temperature being relative to the thermoplastic part of the TPE. Thus, the flexible blocks of the TPEs are defined by a Tg which is less than ambient temperature (25° C.), while the rigid blocks have a Tg which is greater than 80° C.

In order to be both elastomeric and thermoplastic in nature, the TPE has to be provided with blocks which are sufficiently incompatible (that is to say, different as a result of their respective weights, their respective polarities or their respective Tg values) to retain their own properties of elastomer block or thermoplastic block.

The TPEs can be copolymers with a small number of blocks (less than 5, typically 2 or 3), in which case these blocks preferably have high weights of greater than 15 000 g/mol. These TPEs can, for example, be diblock copolymers, comprising a thermoplastic block and an elastomer block. They are often also triblock elastomers with two rigid segments connected by one flexible segment. The rigid and flexible segments can be positioned linearly, or in a star or branched configuration. Typically, each of these segments or blocks often comprises a minimum of more than 5, generally of more than 10, base units (for example, styrene units and butadiene units for a styrene/butadiene/styrene block copolymer).

The TPEs can also comprise a large number of smaller blocks (more than 30, typically from 50 to 500), in which case these blocks preferably have relatively low weights, for example from 500 to 5000 g/mol; these TPEs will subsequently be referred to as multiblock TPEs and are an elastomer block/thermoplastic block series.

According to a first alternative form, the TPE is provided in a linear form. For example, the TPE is a diblock copolymer: thermoplastic block/elastomer block. The TPE can also be a triblock copolymer: thermoplastic block/elastomer block/thermoplastic block, that is to say a central elastomer block and two terminal thermoplastic blocks, at each of the two ends of the elastomer block. Equally, the multiblock TPE can be a linear series of elastomer blocks/thermoplastic blocks.

According to another alternative form of the invention, the TPE of use for the requirements of the invention is provided in a star-branched form comprising at least three branches. For example, the TPE can then be composed of a star-branched elastomer block comprising at least three branches and of a thermoplastic block located at the end of each of the branches of the elastomer block. The number of branches of the central elastomer can vary, for example, from 3 to 12 and preferably from 3 to 6.

According to another alternative form of the invention, the TPE is provided in a branched or dendrimer form. The TPE can then be composed of a branched or dendrimer elastomer block and of a thermoplastic block located at the end of the branches of the dendrimer elastomer block.

### 1.1.2. Nature of the Elastomer Blocks

For the requirements of the invention, the elastomer blocks of the TPE can be all the elastomers known to a person skilled in the art. They generally have a Tg of less than 25° C., preferably of less than 10° C., more preferably of less than 0° C. and very preferably of less than −10° C. Preferably again, the Tg elastomer block of the TPE is greater than −100° C.

For the elastomer blocks comprising a carbon-based chain, if the elastomer part of the TPE does not comprise an ethylenic unsaturation, it will be referred to as a saturated elastomer block. If the elastomer block of the TPE comprises ethylenic unsaturations (that is to say, carbon-carbon double bonds), it will then be referred to as an unsaturated or diene elastomer block.

A saturated elastomer block is composed of a polymer sequence obtained by the polymerization of at least one (that is to say, one or more) ethylenic monomer, that is to say, a monomer comprising a carbon-carbon double bond. Mention may be made, among the blocks resulting from these ethylenic monomers, of polyalkylene blocks, such as ethylene/propylene or ethylene/butylene random copolymers. These saturated elastomer blocks can also be obtained by hydrogenation of unsaturated elastomer blocks. They can also be aliphatic blocks resulting from the families of the polyethers, polyesters or polycarbonates.

In the case of saturated elastomer blocks, this elastomer block of the TPE is preferably predominantly composed of ethylenic units. Predominantly is understood to mean the highest content by weight of ethylenic monomer, with respect to the total weight of the elastomer block, and preferably a content by weight of more than 50%, more preferably of more than 75% and more preferably still of more than 85%.

Conjugated C₄-C₁₄ dienes can be copolymerized with the ethylenic monomers. They are, in this case, random copolymers. Preferably, these conjugated dienes are chosen from isoprene, butadiene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 1,3-hexadiene, 2-methyl-1,3-hexadiene, 3-methyl-1,3-hexadiene, 4-methyl-1,3-hexadiene, 5-methyl-1,3-hexadiene, 2,3-dimethyl-1,3-hexadiene, 2,4-dimethyl-1,3-hexadiene, 2,5-dimethyl-1,3-hexadiene, 2-neopentylbutadiene, 1,3-cyclopentadiene, 1,3-cyclohexadiene, 1-vinyl-1,3-cyclohexadiene or their mixture. More preferably, the conjugated diene is chosen from butadiene or isoprene or a mixture comprising butadiene and isoprene.

In the case of unsaturated elastomer blocks, this elastomer block of the TPE is preferably predominantly composed of a diene elastomer part. Predominantly is understood to mean the highest content by weight of diene monomer, with respect to the total weight of the elastomer block, and preferably a content by weight of more than 50%, more preferably of more than 75% and more preferably still of more than 85%. Alternatively, the unsaturation of the unsaturated elastomer block can originate from a monomer comprising a double bond and an unsaturation of cyclic type; this is the case, for example, in polynorbornene.

Preferably, conjugated C₄-C₁₄ dienes can be polymerized or copolymerized in order to form a diene elastomer block. Preferably, these conjugated dienes are chosen from isoprene, butadiene, piperylene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 2,5-dimethyl-1,3-pentadiene, 2-methyl-1,4-pentadiene, 1,3-hexadiene, 2-methyl-1,3-hexadiene, 2-methyl-1,5-hexadiene, 3-methyl-1,3-hexadiene, 4-methyl-1,3-hexadiene, 5-methyl-1,3-hexadiene, 2,5-dimethyl-1,3-hexadiene, 2,5-dimethyl-2,4-hexadiene, 2-neopentyl-1,3-butadiene, 1,3-cyclopentadiene, methylcyclopentadiene, 2-methyl-1, 6-heptadiene, 1,3-cyclohexadiene, 1-vinyl-1,3-cyclohexadiene or their mixture. More preferably, the conjugated diene is isoprene or butadiene or a mixture comprising isoprene and/or butadiene.

According to an alternative form, the monomers polymerized in order to form the elastomer part of the TPE can be randomly copolymerized with at least one other monomer, so as to form an elastomer block. According to this alternative form, the molar fraction of polymerized monomer, other than an ethylenic monomer, with respect to the total number of units of the elastomer block, has to be such that this block retains its elastomer properties. Advantageously, the molar fraction of this other comonomer can range from 0% to 50%, more preferably from 0% to 45% and more preferably still from 0% to 40%.

By way of illustration, this other monomer capable of copolymerizing with the first monomer can be chosen from ethylenic monomers as defined above (for example ethylene), diene monomers, more particularly the conjugated diene monomers having from 4 to 14 carbon atoms as defined above (for example butadiene), monomers of vinylaromatic type having from 8 to 20 carbon atoms as defined above, or also a monomer such as vinyl acetate may be involved.

When the comonomer is of vinylaromatic type, it advantageously represents a fraction of units, with regard to the total number of units of the thermoplastic block, from 0% to 50%, preferably ranging from 0% to 45% and more preferably still ranging from 0% to 40%. The styrene monomers mentioned above, namely methylstyrenes, para(tert-butyl)styrene, chlorostyrenes, bromostyrenes, fluorostyrenes or also para-hydroxystyrene, are suitable in particular as vinylaromatic compounds. Preferably, the comonomer of vinylaromatic type is styrene.

According to a preferred embodiment of the invention, the elastomer blocks of the TPE exhibit, in total, a number-average molecular weight (Mn) ranging from 25 000 g/mol to 350 000 g/mol, preferably from 35 000 g/mol to 250 000 g/mol, so as to confer, on the TPE, good elastomeric properties and a mechanical strength which is sufficient and compatible with the use as tyre underlayer.

The elastomer block can also be a block comprising several types of ethylenic, diene or styrene monomers as defined above.

The elastomer block can also be composed of several elastomer blocks as defined above.

### 1.1.3. Nature of the Thermoplastic Blocks

Use will be made, for the definition of the thermoplastic blocks, of the characteristic of glass transition temperature (Tg) of the rigid thermoplastic block. This characteristic is well known to a person skilled in the art. It makes it possible in particular to choose the industrial processing (transformation) temperature. In the case of an amorphous polymer (or polymer block), the processing temperature is chosen to be substantially greater than the Tg of the thermoplastic block. In the specific case of a semicrystalline polymer (or polymer block), a melting point may be observed which is then greater than the glass transition temperature. In this case, it is instead the melting point (M.p.) which makes it possible to choose the processing temperature for the polymer (or polymer block) under consideration. Thus, subsequently, when reference will be made to “Tg (or M.p., if appropriate)”, it will be necessary to consider that this is the temperature used to choose the processing temperature.

For the requirements of the invention, the TPE elastomers comprise one or more thermoplastic block(s) preferably having a Tg (or M.p., if appropriate) of greater than or equal to 80° C. and formed from polymerized monomers. Preferably, this thermoplastic block has a Tg (or M.p., if appropriate) within a range varying from 80° C. to 250° C. Preferably, the Tg (or M.p., if appropriate) of this thermoplastic block is preferably from 80° C. to 200° C., more preferably from 80° C. to 180° C.

The proportion of the thermoplastic blocks, with respect to the TPE as defined for the implementation of the invention, is determined, on the one hand, by the thermoplasticity properties which the said copolymer has to exhibit. The thermoplastic blocks having a Tg (or M.p., if appropriate) of greater than or equal to 80° C. are preferably present in proportions sufficient to retain the thermoplastic nature of the elastomer according to the invention. The minimum content of thermoplastic blocks having a Tg (or M.p., if appropriate) of greater than or equal to 80° C. in the TPE can vary as a function of the conditions of use of the copolymer. On the other hand, the ability of the TPE to deform during the preparation of the tyre can also contribute to determining the proportion of the thermoplastic blocks having a Tg (or M.p., if appropriate) of greater than or equal to 80° C.

The thermoplastic blocks having a Tg (or M.p., if appropriate) of greater than or equal to 80° C. can be formed from polymerized monomers of various natures; in particular, they can constitute the following blocks or their mixtures:
polyolefins (polyethylene, polypropylene);
polyurethanes;
polyamides;
polyesters;
polyacetals;
polyethers (polyethylene oxide, polyphenylene ether);
polyphenylene sulphides;
polyfluorinated compounds (FEP, PFA, ETFE);
polystyrenes (described in detail below);
polycarbonates;
polysulphones;
polymethyl methacrylate;
polyetherimide;
thermoplastic copolymers, such as the acrylonitrile/butadiene/styrene (ABS) copolymer.

The thermoplastic blocks having a Tg (or M.p., if appropriate) of greater than or equal to 80° C. can also be obtained from monomers chosen from the following compounds and their mixtures:
acenaphthylene: a person skilled in the art may refer, for example, to the paper by Z. Fodor and J. P. Kennedy, Polymer Bulletin, 1992, 29(6), 697-705;
indene and its derivatives, such as, for example, 2-methylindene, 3-methylindene, 4-methylindene, dimethylindenes, 2-phenylindene, 3-phenylindene and 4-phenylindene; a person skilled in the art may, for example, refer to the patent document U.S. Pat. No. 4,946,899, by the inventors Kennedy, Puskas, Kaszas and Hager, and to the documents by J. E. Puskas, G. Kaszas, J. P. Kennedy and W. G. Hager, Journal of Polymer Science, Part A, Polymer Chemistry (1992), 30, 41, and J. P. Kennedy, N. Meguriya and B. Keszler, Macromolecules (1991), 24(25), 6572-6577;
isoprene, then resulting in the formation of a certain number of trans-1,4-polyisoprene units and of units cyclized according to an intramolecular process; a person skilled in the art may, for example, refer to the documents by G. Kaszas, J. E. Puskas and J. P. Kennedy, Applied Polymer Science (1990), 39(1), 119-144, and J. E. Puskas, G. Kaszas and J. P. Kennedy, Macromolecular Science, Chemistry A28 (1991), 65-80.

The polystyrenes are obtained from styrene monomers. Styrene monomer should be understood as meaning, in the present description, any monomer comprising styrene, unsubstituted and substituted; mention may be made, among substituted styrenes, for example, of methylstyrenes (for example, o-methylstyrene, m-methylstyrene or p-methyl styrene, α-methyl styrene, α,2-dimethyl styrene, α,4-dimethyl styrene or diphenylethylene), para-(tert-butyl)styrene, chlorostyrenes (for example, o-chlorostyrene, m-chlorostyrene, p-chlorostyrene, 2,4-dichlorostyrene, 2,6-dichlorostyrene or 2,4,6-trichlorostyrene), bromostyrenes (for example, o-bromostyrene, m-bromostyrene, p-bromostyrene, 2,4-dibromostyrene, 2,6-dibromostyrene or 2,4,6-tribromostyrene), fluorostyrenes (for example, o-fluorostyrene, m-fluorostyrene, p-fluorostyrene, 2,4-difluorostyrene, 2,6-difluorostyrene or 2,4,6-trifluorostyrene) or also para-hydroxystyrene.

According to a preferred embodiment of the invention, the content by weight of styrene in the TPE elastomer is between 5% and 50%. Below the minimum indicated, there is a risk of the thermoplastic nature of the elastomer being substantially reduced while, above the recommended maximum, the elasticity of the underlayer can be affected. For these reasons, the styrene content is more preferably between 10% and 40%.

According to an alternative form of the invention, the polymerized monomer as defined above can be copolymerized with at least one other monomer, so as to form a thermoplastic block having a Tg (or M.p., if appropriate) as defined above.

By way of illustration, this other monomer capable of copolymerizing with the polymerized monomer can be chosen from diene monomers, more particularly conjugated diene monomers having from 4 to 14 carbon atoms, and monomers of vinylaromatic type having from 8 to 20 carbon atoms, such as defined in the part relating to the elastomer block.

According to the invention, the thermoplastic blocks of the TPE exhibit, in total, a number-average molecular weight (“Mn”) ranging from 5 000 g/mol to 150 000 g/mol, so as to confer, on the TPE, good elastomeric properties and a mechanical strength which is sufficient and compatible with the use as tyre underlayer.

The thermoplastic block can also be composed of several thermoplastic blocks as defined above.

### 1.1.4. TPE Examples

For example, the TPE is a copolymer, the elastomer part of which is saturated and which comprises styrene blocks and alkylene blocks. The alkylene blocks are preferably of ethylene, propylene or butylene. More preferably, this TPE elastomer is selected from the following group consisting of diblock or triblock copolymers which are linear or star-branched: styrene/ethylene/butylene (SEB), styrene/ethylene/propylene (SEP), styrene/ethylene/ethylene/propylene (SEEP), styrene/ethylene/butylene/styrene (SEBS), styrene/ethylene/propylene/styrene (SEPS), styrene/ethylene/ethylene/propylene/styrene (SEEPS), styrene/isobutylene (SIB), styrene/isobutylene/styrene (SIBS) and the mixtures of these copolymers.

According to another example, the TPE is a copolymer, the elastomer part of which is unsaturated and which comprises styrene blocks and diene blocks, these diene blocks being in particular isoprene or butadiene blocks. More preferably, this TPE elastomer is selected from the following group consisting of diblock or triblock copolymers which are linear or star-branched: styrene/butadiene (SB), styrene/isoprene (SI), styrene/butadiene/isoprene (SBI), styrene/butadiene/styrene (SBS), styrene/isoprene/styrene (SIS), styrene/butadiene/isoprene/styrene (SBIS) and the mixtures of these copolymers.

For example again, the TPE is a linear or star-branched copolymer, the elastomer part of which comprises a saturated part and an unsaturated part, such as, for example, styrene/butadiene/butylene (SBB), styrene/butadiene/butylene/styrene (SBBS) or a mixture of these copolymers.

Mention may be made, among multiblock TPEs, of the copolymers comprising random copolymer blocks of ethylene and propylene/polypropylene, polybutadiene/polyurethane (TPU), polyether/polyester (COPE) or polyether/polyamide (PEBA).

It is also possible for the TPEs given as example above to be mixed with one another within the underlayer according to the invention.

Mention may be made, as examples of commercially available TPE elastomers, of the elastomers of SEPS, SEEPS or SEBS type sold by Kraton under the Kraton G name (e.g., G1650, G1651, G1654 and G1730 products) or Kuraray under the Septon name (e.g., Septon 2007, Septon 4033 or Septon 8004), or the elastomers of SIS type sold by Kuraray under the name Hybrar 5125 or sold by Kraton under the name D1161, or also the elastomers of linear SBS type sold by Polimeri Europa under the name Europrene SOLT 166 or of star-branched SBS type sold by Kraton under the name D1184. Mention may also be made of the elastomers sold by Dexco Polymers under the Vector name (e.g., Vector 4114 or Vector 8508). Mention may be made, among multiblock TPEs, of the Vistamaxx TPE sold by Exxon; the COPE TPE sold by DSM under the Arnitel name or by DuPont under the Hytrel name or by Ticona under the Riteflex name; the PEBA TPE sold by Arkema under the PEBAX name; or the TPU TPE sold by Sartomer under the name TPU 7840 or by BASF under the Elastogran name.

### 1.1.5. Amount of TPE

If optional other (non-thermoplastic) elastomers are used in the composition, the thermoplastic elastomer or elastomers (TPE) constitute the predominant fraction by weight; they then represent at least 65% by weight, preferably at least 70% by weight and more preferably at least 75% by weight of the combined elastomers present in the elastomer composition. Preferably again, the TPE elastomer or elastomers represent at least 95% (in particular 100%) by weight of the combined elastomers present in the elastomer composition.

Thus, the total amount of TPE elastomer is within a range which varies from 65 to 100 phr, preferably from 70 to 100 phr and in particular from 75 to 100 phr. Preferably again, the composition comprises from 95 to 100 phr of TPE elastomer. The TPE elastomer or elastomers are preferably the only elastomer or elastomers of the underlayer.

### 1.2. Conductive Filler

The thermoplastic elastomer or elastomers described above are additivated with conductive filler in order to form the underlayer according to the invention, the said conductive filler being a graphitized or partially graphitized carbon black.

In a way known to a person skilled in the art, a conductive filler is a compound which, introduced into a medium, in the presence of an electric current, brings about the appearance of an electric current in the medium.

The conductive filler is a graphitized or partially graphitized carbon black, also known as conductive blacks. These conductive blacks are, for example, sold by Timcal under the “Ensaco 350G” tradename, with a specified surface (BET, measured according to the standard ASTM D3037) of 770 m²/g, or the “Ensaco 260G” tradename, with a specific surface of 70 m²/g. Very preferably, the conductive filler is a graphitized or electric conductive carbon black with a specified surface (BET, measured by the standard ASTM D3037) of greater than 65 m²/g, more preferably of greater than 100 m²/g and very preferably of greater than 500 m²/g.

The amount of conductive filler in the composition of the underlayer of the invention is preferably within a range extending from 10% to 25% by volume, preferably from 10% to 18% by volume and more preferably from 12% to 18% by volume.

These preferred contents by volume correspond approximately to contents by phr, also preferred, within a range extending from 20 to 50 phr, preferably from 20 to 40 phr and more preferably from 30 to 40 phr.

### 1.3. Non-Thermoplastic Elastomer

The thermoplastic elastomer or elastomers and the conductive filler described above are sufficient by themselves alone for the underlayer according to the invention to be usable.

The composition of the underlayer according to the invention can comprise at least one (that is to say, one or more) diene rubber as non-thermoplastic elastomer, it being possible for this diene rubber to be used alone or as a blend with at least one (that is to say, one or more) other non-thermoplastic rubber or elastomer.

The total content of optional non-thermoplastic elastomer is within a range varying from 0 to 35 phr, preferably from 0 to 30 phr, more preferably from 0 to 25 phr and more preferably still from 0 to 5 phr. Preferably again, the underlayer of the tyre according to the invention does not comprise a non-thermoplastic elastomer.

“Diene” elastomer or rubber should be understood, in a known way, as meaning an (one or more is understood) elastomer resulting at least in part (i.e., a homopolymer or a copolymer) from diene monomers (monomers bearing two conjugated or non-conjugated carbon-carbon double bonds).

These diene elastomers can be classified into two categories: “essentially unsaturated” or “essentially saturated”.

“Essentially unsaturated” is generally understood to mean a diene elastomer resulting at least in part from conjugated diene monomers having a content of units of diene origin (conjugated dienes) which is greater than 15% (mol %). In the category of “essentially unsaturated” diene elastomers, a “highly unsaturated” diene elastomer is understood in particular to mean a diene elastomer having a content of units of diene origin (conjugated dienes) which is greater than 50%.

Thus it is that diene elastomers such as some butyl rubbers or copolymers of dienes and of α-olefins of EPDM type can be described as “essentially saturated” diene elastomers (low or very low content of units of diene origin, always less than 15%).

Given these definitions, diene elastomer, whatever the above category, capable of being used in the compositions in accordance with the invention is understood more particularly to mean:

(a)—any homopolymer obtained by polymerization of a conjugated diene monomer having from 4 to 12 carbon atoms;
(b)—any copolymer obtained by copolymerization of one or more conjugated dienes with one another or with one or more vinylaromatic compounds having from 8 to 20 carbon atoms;
(c)—a ternary copolymer obtained by copolymerization of ethylene and an α-olefin having from 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, in particular, 1,4-hexadiene, ethylidenenorbornene or dicyclopentadiene;
(d)—a copolymer of isobutene and isoprene (diene butyl rubber) and also the halogenated versions, in particular chlorinated or brominated versions, of this type of copolymer.

Any type of diene elastomer can be used in the invention. When the composition comprises a vulcanization system, use is preferably made of essentially unsaturated elastomers, in particular of the (a) and (b) types above, in the manufacture of the underlayer of the tyre according to the present invention.

The following are suitable in particular as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. The following, for example, are suitable as vinylaromatic compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

The copolymers can comprise between 99% and 20% by weight of diene units and between 1% and 80% by weight of vinylaromatic units. The elastomers can have any microstructure, which depends on the polymerization conditions used, in particular on the presence or absence of a modifying and/or randomizing agent and on the amounts of modifying and/or randomizing agent employed. The elastomers can, for example, be prepared in dispersion or in solution; they can be coupled and/or star-branched or else functionalized with a coupling and/or star-branching or functionalization agent. Mention may be made, for example, for coupling to carbon black, of functional groups comprising a C—Sn bond or aminated functional groups, such as benzophenone, for example; mention may be made, for example, for coupling to a reinforcing inorganic filler, such as silica, of silanol functional groups or polysiloxane functional groups having a silanol end (such as described, for example, in FR 2 740 778 or U.S. Pat. No. 6,013,718), alkoxysilane groups (such as described, for example, in FR 2 765 882 or U.S. Pat. No. 5,977,238), carboxyl groups (such as described, for example, in WO 01/92402 or U.S. Pat. No. 6,815,473, WO 2004/096865 or US 2006/0089445) or else polyether groups (such as described, for example, in EP 1 127 909 or U.S. Pat. No. 6,503,973). Mention may also be made, as other examples of functionalized elastomers, of elastomers (such as SBR, BR, NR or IR) of the epoxidized type.

### 1.4. Polyether-Based Thermoplastic Polymer

The underlayer described above can optionally comprise, in addition to constituents presented above, one or more polyether-based thermoplastic polymers. When they are present in the composition, it is preferable for the total content of polyether-based thermoplastic polymers to be less than 40 phr, preferably between 2 and 35 phr, more preferably between 5 and 30 phr and very preferably between 10 and 25 phr. These thermoplastic polymers can in particular be poly(para-phenylene ether) polymers (denoted by the abbreviation “PPE”). These PPE thermoplastic polymers are well known to a person skilled in the art; they are resins, which are solid at ambient temperature (20° C.) and which are compatible with styrene polymers, which are used in particular to increase the Tg of TPE elastomers, the thermoplastic block of which is a styrene block (see, for example, “Thermal, Mechanical and Morphological Analyses of Poly(2,6-dimethyl-1,4-phenylene oxide)/Styrene-Butadiene-Styrene Blends”, Tucker, Barlow and Paul, Macromolecules, 1988, 21, 1678-1685).

### 1.5. Nanometric or Reinforcing Filler

The thermoplastic elastomer described above and the conductive filler are sufficient by themselves alone for the underlayer according to the invention to be usable; nevertheless, a reinforcing filler can be used in the composition.

When a reinforcing filler is used, use may be made of any type of filler commonly used for the manufacture of tyres, for example an organic filler, such as carbon black, an inorganic filler, such as silica, or else a blend of these two types of filler, in particular a blend of carbon black and silica.

When a reinforcing inorganic filler is used, it is possible, for example, to use, in a known way, an at least bifunctional coupling agent (or bonding agent) intended to provide a satisfactory connection, of chemical and/or physical nature, between the inorganic filler (surface of its particles) and the elastomer, in particular bifunctional organosilanes or polyorganosiloxanes.

### 1.6. Various Additives

The underlayer described above can furthermore comprise the various additives normally present in the underlayers known to a person skilled in the art. The choice will be made, for example, of one or more additives chosen from protection agents, such as antioxidants or antiozonants, UV stabilizers, the various processing aids or other stabilizers, or also promoters capable of promoting the adhesion to the remainder of the structure of the tyre. Preferably, the underlayer does not comprise all these additives at the same time and, more preferably still, the underlayer does not comprise any of these agents.

Equally and optionally, the composition of the underlayer of the invention can comprise a crosslinking system known to a person skilled in the art. Preferably, the composition does not comprise a crosslinking system. In the same way, the composition of the underlayer of the invention can comprise one or more inert micrometric fillers, such as lamellar fillers, known to a person skilled in the art. Preferably, the composition does not comprise a micrometric filler.

Optionally again, the composition of the underlayer of the invention can comprise a plasticizing agent, such as an extending oil (or plasticizing oil) or a plasticizing resin, the role of which is to facilitate the processing of the underlayer, in particular its incorporation in the tyre, by a lowering of the modulus and an increase in the tackifying power. When the composition comprises it, it is preferable for the content of plasticizer to vary from 0 to 80 phr, more preferably from 0 to 50 phr, more preferably still from 0 to 30 phr, and in particular less than 10 phr, according to the Tg and the modulus which are targeted for the underlayer. According to a preferred alternative form of the invention, the composition of the underlayer does not comprise a plasticizer.

In addition to the elastomers described above, the composition of the underlayer can also comprise, always according to a minor fraction by weight with respect to the block elastomer, thermoplastic polymers other than those based on polyether. It is preferable for the composition not to comprise such thermoplastic polymers other than those based on polyether or, when they are present in the composition, it is preferable for the total content of thermoplastic polymers other than those based on polyether to be less than 30 phr, preferably less than 10 phr. Very preferably, the composition is devoid of such thermoplastic polymers other than those based on polyethers or comprises less than 5 phr thereof.

### 2. Preparation of the Underlayer and of the Tyre According to the Invention

The TPE elastomers can be processed in the usual way for TPEs, by extrusion or moulding, for example using a starting material available in the form of beads or granules.

The underlayer for the tyre according to the invention is prepared in the usual way, for example by incorporation of the various components in a twin-screw extruder, so as to carry out the melting of the matrix and the incorporation of all the ingredients, followed by use of a die which makes it possible to produce the profiled element.

This underlayer can be fitted to a tyre in the usual way, the said tyre comprising, in addition to the underlayer necessary for the requirements of the invention, a tread, a crown and a crown reinforcement, and preferably two sidewalls and two beads, and a carcass reinforcement anchored to the two beads and extending from one sidewall to the other.

Preferably, in the tyre according to the invention, the difference between the ratio of elastic modulus at 200° C. and at 60° C. of the underlayer and that of the adjacent layers is such that the following equation is adhered to with each of the adjacent layers:

$$\frac{\frac{{G}_{A}^{′} ( 200 ° C . )}{{G}_{A}^{′} ( 60 ° C . )}}{\frac{{G}_{B}^{′} ( 200 ° C . )}{{G}_{B}^{′} ( 60 ° C . )}} \leq 0.6$$

in which G_{A}′(T) represents the elastic component of the shear modulus of the underlayer at the temperature T and G_{B}′(T) represents the elastic component of the shear modulus of the layer adjacent to the underlayer at the temperature T. This is because, when this equation is adhered to, it is understood that the underlayer will soften much more before 200° C. than the adjacent layer, which is an important condition for a facilitated tread separation.

This difference between the variations in modulus of the underlayer and of the adjacent layers is of use in easily bringing about, by heating, the separation of the worn tread from the remainder of the structure of the tyre and in greatly simplifying the tread separation operation. Furthermore, once the tread has been lifted off by softening of the tread underlayer, the presence of a thermoplastic elastomer residue on the remaining structure of the tyre (also known as “carcass”) makes possible facilitated retreading by using a new tread also exhibiting, in its lower part, an underlayer comprising a thermoplastic elastomer of identical or compatible nature (that is to say, similar in its chemical composition, its weight, its polarity and/or its glass transition temperature Tg). It is consequently sufficient to bring the tread-separated structure of the tyre into contact with the tread and to apply a sufficient temperature and a sufficient pressure at the interface to bring about the fusion of the two thermoplastic layers and to thus obtain a new retreaded tyre. This operation might be repeated virtually indefinitely, limited only by the lifetime of the carcass.

Preferably, the difference between the ratio of elastic modulus at 200° C. and at 60° C. of the underlayer and that of the adjacent layers is such that the following equation is adhered to:

$$\frac{\frac{{G}_{A}^{′} ( 200 ° C . )}{{G}_{A}^{′} ( 60 ° C . )}}{\frac{{G}_{B}^{′} ( 200 ° C . )}{{G}_{B}^{′} ( 60 ° C . )}} \leq 0.5$$

and, more preferably, the difference between the ratio of elastic modulus at 200° C. and at 60° C. of the underlayer and that of the adjacent layers is such that the following equation is adhered to:

$$\frac{\frac{{G}_{A}^{′} ( 200 ° C . )}{{G}_{A}^{′} ( 60 ° C . )}}{\frac{{G}_{B}^{′} ( 200 ° C . )}{{G}_{B}^{′} ( 60 ° C . )}} \leq 0.45$$

According to the tyre applications targeted, it can be preferable for the underlayer to have elastic modulus properties such that the following equation is adhered to:

$$\frac{{G}_{A}^{′} ( 100 ° C . )}{{G}_{A}^{′} ( 60 ° C . )} > 0.4$$

This is because a slight elastic modulus variation between 60° C. and 100° C. is a good indicator of the fact that the underlayer has not excessively softened at these temperatures, which is desirable for the satisfactory operation of the tyre, in particular if it is intended for tyres of passenger vehicles or heavy-duty vehicles, which have an operating temperature exceeding the values of 60° C.

Preferably, the underlayer has elastic modulus properties such that the following equation is adhered to:

$$\frac{{G}_{A}^{′} ( 100 ° C . )}{{G}_{A}^{′} ( 60 ° C . )} > 0.5$$

Preferably, the underlayer has elastic modulus properties such that the following equation is adhered to:

$$\frac{{G}_{A}^{′} ( 100 ° C . )}{{G}_{A}^{′} ( 60 ° C . )} > 0.6$$

Preferably, the underlayer has elastic modulus properties such that the following equation is adhered to:

$$\frac{{G}_{A}^{′} ( 100 ° C . )}{{G}_{A}^{′} ( 60 ° C . )} > 0.7$$

Alternatively, the possibility of facilitated tread separation is also represented by the difference between the variation in elastic modulus between 60° C. and 200° C. of the underlayer and that of the adjacent layers, when the following equation is adhered to with each of the adjacent layers:

$$\frac{\frac{{E}_{A}^{′} ( 200 ° C . )}{{E}_{A}^{′} ( 60 ° C . )}}{\frac{{E}_{B}^{′} ( 200 ° C . )}{{E}_{B}^{′} ( 60 ° C . )}} \leq 0.6$$

in which E′_{A}(T) represents the elastic component of the shear modulus of the underlayer at the temperature T and E′_{B}(T) represents the elastic component of the shear modulus of the layer adjacent to the underlayer at the temperature T. In this case, the E′(T) modulus is measured in compression.

Thus, the invention can be defined by replacing the equation comprising the ratios of G′ moduli by the above equation comprising the ratios of E′ moduli. The same embodiments can be envisaged and the preferences indicated above apply mutatis mutandis.

The layers adjacent to the tread underlayer are typically the tread, on the one hand, and the belt (or crown reinforcement) of the tyre, on the other hand.

In the case where the tread underlayer is located inside the original tread, it is understood that the two adjacent layers are, on the one hand, the upper part of the tread (radially outer, forming the subject of the tread separation) and, on the other hand, the lower part (radially inner with respect to the underlayer) of the original tread. In this case, it is possible for the two adjacent layers of the underlayer to be identical or different in nature.

According to a preferred embodiment, the adjacent layers can be composed of compositions based on diene elastomers well-known to a person skilled in the art, such as those defined above as optional complementary elastomers of the thermoplastic elastomers of the underlayer.

Such adjacent layers are described in numerous patents well-known to a person skilled in the art and generally comprise, in addition to the diene elastomers described above, additives such as those described above for the composition of the underlayer and in particular reinforcing fillers, such as silica and/or carbon black, plasticizers in the form of plasticizing oil or plasticizing resin, a crosslinking system and other additives well-known to a person skilled in the art, such as antioxidants.

According to another preferred embodiment, the adjacent layers can also be composed of compositions based on thermoplastic elastomers or comprising thermoplastic elastomers, and in particular this can be the case of the tread.

According to yet another preferred embodiment, one of the adjacent layers can be a layer composed of a composition based on diene elastomer (in particular the tyre belt), whereas the other adjacent layer can be composed of a composition based on thermoplastic elastomer (in particular the tread).

### Exemplary Embodiments of the Invention

Underlayer compositions for a tyre according to the invention were prepared as indicated above.

The possibility of facilitated tread separation from the tyres according to the invention can be evaluated by tests carried out on different underlayer compositions and different adjacent layer compositions as indicated below.

Measurements of E′(T)

The method of measurement of E′(T) is carried out using a DMA METRAVIB 450+ device equipped with PET10003000B compression plates.

The test carried out is a dynamic compression test on a cylindrical sample having a diameter of 10 mm and a height of 15 mm.

The TPE formulation or the raw elastomer mixture chosen is first formed into sheets (e.g., under a press for the TPE and on an open mill for the elastomer mixture). Small discs with a diameter of 10 mm will subsequently be cut out using a hollow punch. These discs are stacked until a height of at least 15 mm is obtained.

These stacked discs are subsequently placed in a mould, the internal dimensions of which are a diameter of 10 mm and a height of 15 mm. The assembly is passed into a press in order to melt the non-crosslinkable mixture or to cure the crosslinkable mixture and to constitute a cylindrical sample with a diameter of 10 mm and a height of 15 mm.

Typically, this curing (for the crosslinkable mixture) or forming (for the non-crosslinkable mixture) heat treatment is at 170° C. under 16 bar for 17 min. After forming and, if appropriate, curing, the cylindrical sample obtained is rendered integral with the compression plates using an adhesive, Loctite 406. A drop of this adhesive is first deposited at the centre of the lower plate. The cylindrical sample is positioned on this drop and a second drop is deposited on top of the cylindrical sample. The crosspiece of the Metravib will subsequently be lowered in order to cause the upper plate to adhesively bond to the top of the sample, care being taken not to crush it (virtually zero force).

After drying the adhesive for a few minutes, a sinusoidal stress is applied to this cylindrical sample at a degree of static deformation of 10% and a degree of dynamic deformation of 0.1% at 1 Hz. The variation in the E′ modulus as a function of the temperature is studied for a range varying from 40° C. to 200° C. with a rate of variation of 1° C./min.

Typically, a plot of the change in the E′ modulus as a function of the temperature is then obtained. From this curve, it is possible to extract E′ values at different temperatures, for example E′(60° C.), E′(100° C.) and E′(200° C.).

### Measurements of G′(T)

The method of measurement of G′(T) uses an RPA 2000LV rheology device (oscillating disc rheometer) equipped with the standard 200 in·lbs (22.6 Nm) viscosity sensor. The RPA device makes it possible to stress in torsion a sample of material enclosed in a chamber having biconical walls.

In order to carry out the measurement, a sample of material having a diameter of approximately 30 mm and a weight of approximately 5 g is deposited in the chamber of the RPA (A total volume of 8 cm³ is regarded as optimal; the amount is sufficient when a small amount of sample escapes from each side of the chamber and is visible at the end of the test). Preferably, the material is cut out beforehand from a sheet of this material. In the case where this sheet of material is insufficiently thick, it is possible to stack the sections of this sheet of material.

In a first step, a curing (in the case of a crosslinkable mixture) or a forming (case of a non-crosslinkable mixture) operation is carried out by applying, to the sample enclosed in the chamber, a temperature of 170° C. for 17 min with a shearing of 2.78% (i.e., an angle of 0.19°).

These first stages are in accordance with the conditions provided in Standard ISO 3417 of February 2009, which gives the parameters for preparation and for tests for analysing a vulcanization time of a sample in the rheometer.

At the end of this operation, the sample is completely moulded in the closed chamber of the RPA and, if appropriate, this sample is crosslinked. The sample is subsequently cooled to 40° C. directly in the chamber of the RPA. It is then possible to begin the measurement of the value of G′ at 5% of alternating dynamic shearing (i.e., an angle of 0.36°) and 10 Hz within a temperature range varying from 40 to 200° C.

A curve of variation in G′ as a function of the temperature is obtained, from which the G′ moduli of the composition at 60° C., 100° C. and 200° C. can be extracted.

The stages of forming and, if appropriate, of crosslinking the sample and of measurement of G′ are carried out without intervention, by programming the RPA device.

### Temperature Reached in the Underlayer Subjected to Conduction Heating

The method consists in subjecting the compositions to heating via a conduction landing. An “Elektro-Automatik PSI 8500-30U” supply makes it possible, by means of two copper electrodes which provide the contact, to circulate a direct electric current in the composition sample tested. The supply is controlled by means of the “Easy Power Lite” software, in which it is possible to choose to regulate with regard to intensity, voltage or power. We have chosen to operate at applied power. The thermal camera makes it possible to record the change in the temperature as a function of the time by means of the “Thermacam” software.

### Examples

Underlayer compositions were prepared as indicated above and their temperatures after exposure to an electric current were measured. The compositions are presented in Table 1 below.

TABLE 1

| | Composition | | | | |
|---|---|---|---|---|---|
| | A-1 | A-2 | A-3 | A-4 | A-5 |
| SBS (1) in phr | 100 | 100 | 100 | 100 | 100 |
| PPE (2) in phr | 15 | 15 | 15 | 15 | 15 |
| Ensaco 260 G (3) in phr | 0 | 31 | 39 | 0 | 0 |
| Ensaco 260 G (3) in vol % | 0 | 12.5 | 15 | 0 | 0 |
| Ensaco 350 G (4) in phr | 0 | 0 | 0 | 24 | 31 |
| Ensaco 350 G (4) in vol % | 0 | 0 | 0 | 10 | 12.5 |

(1) Linear SBS thermoplastic elastomer, Europrene SOLT 166, from Polimeri Europa;
(2) Poly(2,6-dimethyl-1,4-phenylene ether), SABIC Noryl SA120;
(3) Conductive carbon black, “Ensaco 260 G” from Timcal
(4) Conductive carbon black, “Ensaco 350 G” from Timcal

The compositions A-2, A-3, A-4 and A-5 correspond to underlayer compositions for the requirements of the invention. There may be noted in these compositions the great saving in means, related to the use of TPE elastomers in the composition of the underlayer. The composition A-1 is a control composition devoid of conductive filler.

The results are presented in Table 2 for the underlayer compositions A-1 to A-5.

TABLE 2

| | Compositions | | | | |
|---|---|---|---|---|---|
| | A-1 | A-2 | A-3 | A-4 | A-5 |
| Actual power with set point | 4 | 30 | 50 | 28 | 100 |
| at 100 W (W) | | | | | |
| Temperature reached after | 30 | 52 | 77 | 58 | 153 |
| 1 minute (° C.) | | | | | |

The results presented in Table 2 demonstrate the excellent temperature rise performance of the underlayers comprising a conductive filler, in comparison with an underlayer not comprising such a filler. Thus, it is noted that the selective heating by conduction of the underlayer in a tyre can be effective and can make it possible very easily to change only the worn tread, while limiting the thermal damage which the adjacent layers might experience during a general heating of the tyre.

1.-23. (canceled)

24. A radial tire for a motor vehicle comprising:
a crown comprising a tread provided with at least a radially outer part intended to come into contact with the road;
two non-stretchable beads, two sidewalls connecting the beads to the tread, a carcass reinforcement passing into the two sidewalls and anchored in the beads;
a crown reinforcement positioned circumferentially between the radially outer part of the tread and the carcass reinforcement; and
a radially inner elastomer layer which is an underlayer, the underlayer having a formulation different from the formulation of the radially outer part of the tread and being positioned circumferentially between the radially outer part of the tread and the crown reinforcement,
wherein the underlayer comprises at least one thermoplastic elastomer, the at least one thermoplastic elastomer being a block copolymer comprising at least one elastomer block and at least one thermoplastic block, the total content of the thermoplastic elastomer being within a range varying from 65 to 100 phr (parts by weight per hundred parts of elastomer), and
wherein the underlayer further comprises at least one conductive filler, the conductive filler being a graphitized or partially graphitized carbon black.

25. The tire according to claim 24, wherein the number-average molecular weight of the thermoplastic elastomer is between 30,000 and 500,000 g/mol.

26. The tire according to claim 24, wherein the at least one elastomer block is selected from elastomers having a glass transition temperature of less than 25° C.

27. The tire according to claim 24, wherein the at least one elastomer block is selected from the group consisting of ethylene elastomers, diene elastomers and mixtures thereof.

28. The tire according to claim 27, wherein the at least one elastomer block is selected from diene elastomers.

29. The tire according to claim 28, wherein the diene elastomers result from isoprene, butadiene or a mixture thereof.

30. The tire according to claim 24, wherein the at least one thermoplastic block is selected from polymers having a glass transition temperature of greater than 80° C. and, in the case of a semicrystalline thermoplastic block, a melting point of greater than 80° C.

31. The tire according to claim 24, wherein the at least one thermoplastic block is selected from the group consisting of polyolefins, polyurethanes, polyamides, polyesters, polyacetals, polyethers, polyphenylene sulphides, polyfluorinated compounds, polystyrenes, polycarbonates, polysulphones, polymethyl methacrylate, polyetherimide, thermoplastic copolymers and mixtures thereof.

32. The tire according to claim 31, wherein the at least one thermoplastic block is selected from polystyrenes.

33. The tire according to claim 24, wherein the at least one thermoplastic elastomer is selected from the group consisting of styrene/butadiene, styrene/isoprene, styrene/butadiene/isoprene, styrene/butadiene/styrene, styrene/isoprene/styrene and styrene/butadiene/isoprene/styrene thermoplastic elastomers and mixtures thereof.

34. The tire according to claim 24, wherein the conductive filler is an electric conductive carbon black with a specific surface of greater than 65 m²/g.

35. The tire according to claim 34, wherein the conductive filler is an electric conductive carbon black with a specific surface of greater than 100 m²/g.

36. The tire according to claim 35, wherein the conductive filler is an electric conductive carbon black with a specific surface of greater than 500 m²/g.

37. The tire according to claim 24, wherein the conductive filler is present at a content of from 10% to 25% by volume of the underlayer composition.

38. The tire according to claim 37, wherein the conductive filler is present at a content of from 10% to 18% by volume of the underlayer composition.

39. The tire according to claim 38, wherein the conductive filler is present at a content of from 12% to 18% by volume of the underlayer composition.

40. The tire according to claim 24, wherein the at least one thermoplastic elastomer is the only elastomer of the underlayer.

41. The tire according to claim 24, wherein the underlayer further comprises a non-thermoplastic elastomer at a content of at most 35 phr.

42. The tire according to claim 24, wherein the underlayer further comprises at least one polyether-based thermoplastic polymer.

43. The tire according to claim 42, wherein the polyether-based thermoplastic polymer is selected from poly(para-phenylene ether) polymers.

44. The tire according to claim 42, wherein the content of the polyether-based thermoplastic polymer is less than 40 phr.

45. The tire according to claim 44, wherein the content of the polyether-based thermoplastic polymer is between 2 and 35 phr.

46. The tire according to claim 24, wherein the underlayer is devoid of thermoplastic polymer other than a polyether.

47. The tire according to claim 24, wherein the underlayer comprises less than 30 phr of thermoplastic polymer other than a polyether.

48. The tire according to claim 47, wherein the underlayer comprises less than 10 phr of thermoplastic polymer other than a polyether.

49. The tire according to claim 24, wherein the underlayer does not comprise a crosslinking system.

50. The tire according to claim 24, wherein a difference between the ratio of elastic modulus at 200° C. and at 60° C. of the underlayer and that of layers adjacent to the underlayer is such that the following equation is satisfied for each layer adjacent to the underlayer:
$$\frac{\frac{{G}_{A}^{′} ( 200 ° C . )}{{G}_{A}^{′} ( 60 ° C . )}}{\frac{{G}_{B}^{′} ( 200 ° C . )}{{G}_{B}^{′} ( 60 ° C . )}} \leq 0.6 ,$$
where G′_{A}(200° C.) is the elastic component of the shear modulus of the underlayer at 200° C., where G′_{A}(60° C.) is the elastic component of the shear modulus of the underlayer at 60° C., where G′_{B}(200° C.) is the elastic component of the shear modulus of a layer adjacent to the underlayer at 200° C., and where G′_{B}(60° C.) is the elastic component of the shear modulus of a layer adjacent to the underlayer at 60° C.

51. The tire according to claim 50, wherein the difference between the ratio of elastic modulus at 200° C. and at 60° C. of the underlayer and that of layers adjacent to the underlayer is such that the following equation is satisfied for each layer adjacent to the underlayer:
$$\frac{\frac{{G}_{A}^{′} ( 200 ° C . )}{{G}_{A}^{′} ( 60 ° C . )}}{\frac{{G}_{B}^{′} ( 200 ° C . )}{{G}_{B}^{′} ( 60 ° C . )}} \leq 0.5 .$$

52. The tire according to claim 24, wherein the underlayer has elastic modulus properties such that the following equation is satisfied:
$$\frac{{G}_{A}^{′} ( 100 ° C . )}{{G}_{A}^{′} ( 60 ° C . )} > 0.4 ,$$
where G′_{A}(100° C.) is the elastic component of the shear modulus of the underlayer at 100° C., and where G′_{A}(60° C.) is the elastic component of the shear modulus of the underlayer at 60° C.

53. The tire according to claim 52, wherein the underlayer has elastic modulus properties such that the following equation is satisfied:
$$\frac{{G}_{A}^{′} ( 100 ° C . )}{{G}_{A}^{′} ( 60 ° C . )} > 0.5 .$$
